(19) United States
(12) Patent Application Publication
(10) Pub. No.: US 2024/0123400 A1
(43) Pub. Date: Apr. 18, 2024

(54) SYSTEMS AND METHODS FOR INTEGRATED DIRECT AIR CARBON DIOXIDE CAPTURE AND DESALINATION MINERAL RECOVERY

(71) Applicant: Capture6 Corp., Berkeley, CA (US)

(72) Inventors: Ethan Cohen-Cole, Berkeley, CA (US); Rahul Surana, Fremont, CA (US); Alishan Salim, Spring, TX (US)

(21) Appl. No.: 18/480,779

(22) Filed: Oct. 4, 2023

Related U.S. Application Data
(60) Provisional application No. 63/449,121, filed on Mar. 1, 2023.
(60) Provisional application No. 63/413,021, filed on Oct. 4, 2022.

(51) Int. Cl. B01D 53/62; B01D 53/14; B01D 53/73; C02F 1/44; C02F 1/52; C02F 1/68; C02F 1/76; C02F 9/00; C25B 1/02; C25B 1/20; C25B 15/08

(52) U.S. Cl. CPC B01D 53/62; B01D 53/1425; B01D 53/145; B01D 53/1475; B01D 53/73; C02F 1/441; C02F 1/5236; C02F 1/68; C02F 1/76; C02F 9/00; C25B 1/02; C25B 1/20; C25B 15/081; B01D 2251/604; B01D 2257/504; C02F 2103/08

(57) ABSTRACT

Methods and systems integrate direct carbon capture and desalination processes to various degrees, benefiting from synergies in the combined processes. A method includes receiving an input liquid comprising a brine reject stream from a water treatment facility and pre-treating the input liquid. The pre-treatment includes one or more of filtration, a reverse osmosis, and ion exchange. The method also includes performing an electrochemical process on the input liquid to produce at least one hydroxide-rich stream and capturing CO₂ from air using the hydroxide-rich stream and a passive air capture system, thereby producing a liquid carbonate solution containing air-captured CO₂. In some cases byproducts and recovered water can be used by the water treatment facility and/or the carbon capture process.

### CROSS-REFERENCE TO RELATED APPLICATIONS

This application claims priority under 35 U.S.C. § 119(e) to U.S. Provisional Application No. 63/413,021, filed Oct. 4, 2022, and entitled “CARBON SEQUESTRATION, RARE MINERALS AND METALS EXTRACTION, PARTICULATE REDUCTION, HYDROGEN AND CHLORINE PRODUCTION, AND POST-PROCESSING IN DIRECT AIR CO2 CAPTURE,” and to U.S. Provisional Application No. 63/449,121, filed Mar. 1, 2023, and entitled “SYSTEMS AND METHODS FOR INTEGRATED DIRECT AIR CARBON DIOXIDE CAPTURE AND DESALINATION MINERAL RECOVERY,” both of which are hereby incorporated by reference in their entirety.

### TECHNICAL FIELD

The disclosed technology relates generally to the sequestration, storing, production, extraction, handling, and/or use of elements, compounds, and fluids in conjunction with direct air carbon dioxide (CO₂) capture and desalination of saline water.

### BACKGROUND

Reducing the emissions of climate gases including carbon dioxide is essential to avoiding the worst scenarios for global warming. Curtailing emissions, while essential, is not sufficient by itself, because a stock of CO₂ emissions has been accumulating in the atmosphere since the dawn of the industrial revolution, and countries around the world are not acting sufficiently quickly to reduce their emissions.

The natural processes that uptake this CO₂ released by fossil fuels take a long time to work. As just one example, ocean absorption of CO₂ from the atmosphere takes about a year to equilibrate. Eliminating the balance of CO₂ requires weathering and rock formation—processes that operate on geologic time scales of tens to hundreds of thousands of years.

Given the need to quickly reduce future emissions as well as the existing stock of CO₂, there is a need for approaches that pull existing climate gases (predominantly CO₂) out of the air or water. Removing CO₂ directly from the air is sometimes referred to as Direct Air Carbon Capture and Storage or DACCS.

Current methods for direct air capture of CO₂ typically involve three steps: 1) blowing air over a solvent or sorbent to extract CO₂ from ambient air, 2) heating the solvent or sorbent to release the CO₂ in gaseous form and recover the solvent for recycling, and 3) capturing and sequestering the rereleased CO₂ gas. There is a considerable energy expenditure requirement in performing these steps resulting in additional greenhouse gas emissions, especially from the use of thermal energy required for heating the solvent or sorbent.

Water desalination involves the production of freshwater (sometimes referred to as “product” water) through the removal of dissolved solids (e.g., salts) from an input or feed water. A typical input or feed water is saline water, examples of which include seawater, brackish water, and other salty water with a high level of total dissolved solids (TDS). Desalination processes effectively convert one feed water stream into two output streams. One of the output streams is fresh water with very little to no dissolved solids. The other output stream is brine, which contains the original concentration of dissolved solids as well as the dissolved solids that were once in the freshwater product. The brine thus has a higher concentration of dissolved solids than the original input liquid.

Water pre-treatment and post-treatment are required in many cases to make desalination practical and cost-effective. For example, feed water is often pre-treated with one or more chemical products in order to remove various minerals and/or other substances that may interfere with the desalination process. The recovered fresh water may also be treated to re-mineralize and stabilize the product water in order to, for example, reduce corrosiveness and increase alkalinity.

Producing fresh water through desalination requires handling and disposing of the rejected brine, which now has a higher concentration of dissolved solids than the original feed water. In some cases, the brine reject is spread onto open land so that the water evaporates and the remaining salt can be collected. This approach requires acres of available land, which adds to the cost of desalination. The collected salt must also be disposed of, which results in added landfill waste. Another method for handling the brine reject includes pumping the effluent into the ocean. This approach, however, increases ocean salinity, which can harm the ocean environment. Another method for handling brine reject is to inject the brine into deep wells in the ground. This approach, however, requires careful evaluation and identification of suitable injection sites. All these approaches are expensive and oriented towards storing increasing amounts of waste brine.

### SUMMARY

The disclosed apparatus, systems, and methods relate to the simultaneous capture and sequestration of carbon dioxide and the desalination of saline water. Various implementations of the disclosed technology are directed to aspects of carbon capture and desalination processes that are synergistically combined such that one or more of the byproducts from one process (e.g., the desalination process) are used in the other process (e.g., the carbon capture process), resulting in an efficient overall operation with low carbon emissions and reduced waste. Among other things, various implementations of the disclosed technology use brine waste from the desalination process for the carbon capture process, and thus reduce the amount of brine waste needing to be disposed of or stored.

Traditional desalination facilities extract low TDS water for residential and industrial use from saline water such as seawater or brackish groundwater. In doing so the desalination facility uses energy resulting in carbon dioxide emissions and also creates a high saline brine reject that is often put back into the sea, resulting in an increasing salinity of the sea. Implementations of the disclosed technology relate generally to combined processes that closely integrate a desalination facility and carbon dioxide capture such that the waste streams from the desalination facility (e.g., carbon dioxide emissions and high salinity water) are reduced and possibly eliminated, thus resulting in low or zero emissions and waste systems.

Various implementations according to the disclosed technology incorporate synergistic interdependencies that exist between desalination and carbon dioxide removal. For example, saline water such as seawater or brackish groundwater needs to be disinfected with chlorine-based compounds and filtered to remove elements like calcium that affect the further processing of water. The desalination process also uses energy to pressurize water for reverse osmosis. In various implementations the carbon sequestration process uses salt from the reverse osmosis reject stream, creates chlorine-based byproducts for disinfection, forms sodium carbonate that is used in removing the calcium, and absorbs carbon dioxide that is produced when generating energy from fossil fuel. In various cases the sequestration process produces carbon dioxide, and thus provides a lower cost, “green” source of CO₂ that can be used to remineralize the desalination plant's recovered product water before it is sent out for use (e.g., residential and/or industrial use). Further implementations will be readily apparent to those of skill in the art.

In some cases, various aspects of the apparatus, systems, and/or methods according to the disclosed technology are controlled and/or implemented by a system of one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In Example 1, a method for capturing and sequestering carbon dioxide (CO2), comprising receiving an input liquid comprising a brine reject stream from a water treatment facility, processing the input liquid with one or more of a filtration system, a reverse osmosis system, and an ion exchange system, performing an electrochemical process on the input liquid to produce at least one hydroxide-rich stream, and capturing CO2 from air using the hydroxide-rich stream and a passive air capture system, thereby producing a liquid carbonate solution containing air-captured CO2.

In Example 2, the method of Example 1, further comprising precipitating air-captured CO2 from the liquid carbonate solution.

In Example 3, the method of Example 1, further producing a hydrogen-rich stream with the electrochemical process and mixing the hydrogen-rich stream with the liquid carbonate solution to generate gaseous CO2.

In Example 4, the method of Example 3, further comprising sending the gaseous CO2 to the water treatment facility for remineralizing product water.

In Example 5, the method of Example 1, further comprising precipitating carbonates from the liquid carbonate solution, pre-treating the input liquid with the precipitated carbonates upstream from the electrochemical process, and processing the input liquid with a reverse osmosis system to recover water from the input liquid prior to the electrochemical process.

In Example 6, the method of Example 5, further comprising treating the input liquid and/or the recovered water with a hydrogen-rich stream produced at least in part by the electrochemical process.

In Example 7, the method of Example 1, further comprising mixing CO2 from an industrial CO2 source with the liquid carbonate solution to produce a bicarbonate stream.

In Example 8, a method for capturing and sequestering carbon dioxide (CO2), comprising receiving an input liquid comprising a brine reject stream from a water treatment facility, performing an electrochemical process on the input liquid to produce at least one hydroxide-rich stream, producing a chemical stream with the electrochemical process or downstream from the electrochemical process, using the chemical stream to pre-treat the input liquid upstream from the electrochemical process, and capturing CO2 from air using the hydroxide-rich stream and a passive air capture system, thereby producing a liquid carbonate solution containing air-captured CO2.

In Example 9, the method of Example 8, wherein producing the chemical stream comprises precipitating carbonates from the liquid carbonate solution.

In Example 10, the method of Example 8, wherein producing the chemical stream comprises producing a hydrogen-rich stream at least in part with the electrochemical process.

In Example 11, the method of Example 8, wherein the chemical stream comprises the hydroxide-rich stream.

In Example 12, the method of Example 8, wherein producing the chemical stream comprises mixing CO2 from an industrial CO2 source with the liquid carbonate solution to produce a bicarbonate stream.

In Example 13, a method for capturing and sequestering carbon dioxide (CO2), comprising receiving an input liquid comprising a brine reject stream from a water treatment facility, performing an electrochemical process on the input liquid to produce at least one hydroxide-rich stream, capturing CO2 from air using the hydroxide-rich stream and a passive air capture system, thereby producing a liquid carbonate solution containing air-captured CO2, and producing a water stream comprising recovered water for use by the water treatment facility.

In Example 14, the method of Example 13, further comprising processing the input liquid with reverse osmosis to produce at least part of the recovered water.

In Example 15, the method of Example 13, further comprising processing the liquid carbonate solution to produce at least part of the recovered water.

In Example 16, the method of Example 13, further comprising mixing CO2 from an industrial CO2 source with the liquid carbonate solution to produce a bicarbonate stream and processing the bicarbonate stream to produce at least part of the recovered water.

In Example 17, the method of Example 13, further comprising producing a hydrogen-rich stream at least in part with the electrochemical process.

In Example 18, the method of Example 17, further comprising concentrating the hydrogen-rich stream to produce at least part of the recovered water.

In Example 19, the method of Example 17, wherein the hydrogen-rich stream comprises hydrochloric acid.

In Example 20, the method of Example 17, further comprising generating gaseous CO2 for use by the water treatment facility by mixing the hydrogen-rich stream with the liquid carbonate solution.

A system of one or more computers can be configured to perform particular operations or actions of these Examples by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Other implementations include corresponding computer systems, apparatus, and computer programs recorded on one or more computer storage devices, each configured to perform the actions of the methods.

While multiple embodiments are disclosed, still other embodiments of the disclosure will become apparent to those skilled in the art from the following detailed description, which shows and describes illustrative embodiments of the disclosed apparatus, systems, and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 shows a flow chart of the combined carbon capture and desalination process, according to one implementation.

FIG. 2 shows a summary block diagram of one implementation of the disclosed system including synergies and interdependencies between carbon dioxide capture and sequestration and desalination.

FIG. 3 is a flow chart depicting a carbon capture and mineral recovery process, according to one implementation.

FIG. 4 is a block diagram depicting a carbon removal and mineral recovery system integrated with a water treatment facility according to one implementation.

FIG. 5 is a flow diagram illustrating an example of the carbon capture and mineral recovery system according to one implementation.

FIG. 6 is a flow chart depicting a carbon capture process, according to one implementation.

FIGS. 7-10 are a flow chart depicting a carbon capture process, according to one implementation.

### DETAILED DESCRIPTION

The various examples and implementations disclosed or contemplated herein relate to methods, systems, and devices for integrating the capture and sequestration of carbon dioxide with the desalination of saline water. An aspect of the integration involves recovering one or more minerals (e.g., sodium chloride) from a desalination waste stream. For example, various implementations use the brine reject stream from the desalination process to make up at least part of an input liquid for the direct carbon capture process. The process treats the input liquid to recover sodium chloride from the brine as it produces a high salinity stream for further processing and returns a low TDS water output for use by the desalination process. An electrochemical process such as, for example, electrodialysis (ED) or electrolysis, produces a hydroxide-rich flow from the high salinity stream. The hydroxide-rich stream is then used along with passive airflow over packing structures to directly capture CO₂ from the surrounding air and optionally from the desalination plant exhaust. The hydroxide-rich stream may in some cases also be used for treating sequestration input liquid and/or the desalination feed water.

In various implementations, solid carbonates are precipitated from the resulting liquid carbonate solution. The carbonates are then optionally deposited in a body of water or otherwise stored or used. In some implementations, the liquid carbonate solution is also or instead processed to release and store the captured CO₂ as a gas. In various implementations the resulting liquid carbonate solution, solid carbonates, and/or captured CO₂ gas is used for treating or conditioning one or more of the sequestration input liquid, the desalination feed water, and the recovered freshwater stream produced by the desalination plant.

Additional liquid input can be used to continue the process, so as to operate the process in a continuous fashion. In some cases, the input liquid is saline water such as seawater. In various cases, the input liquid is desalination brine, brackish water, brine effluent, or another salt water. As one example, in various cases, the carbon capture process is integrated with a seawater desalination plant and the input liquid includes the brine reject produced by the desalination plant. As another example, in various implementations, the carbon capture process is integrated with a brackish water desalination plant. In such cases the input liquid includes the brine reject produced by the brackish water desalination plant. In various cases, the input liquid optionally contains a combination of sources, including, for example, desalination brine, seawater, and brackish water.

It will thus be appreciated that various implementations of the disclosed technologies benefit from available synergies by integrating one or more aspects of desalination (either seawater or brackish water) and direct air carbon capture to varying degrees. In the context of desalination, in various implementations, the carbon capture system and process are more fully integrated into the continuous operation of the desalination plant, such that the system continually receives additional brine from desalination while at the same time providing recovered water and/or additional products for use with the desalination cycle. In various implementations, the carbon capture process may be less than fully integrated with the desalination process. In some cases, for example, the carbon capture process and desalination process may use products and/or waste streams from each other as they operate side-by-side or with some amount of separation.

Various implementations of the disclosed technologies may incorporate one or more of several possible integrations. As an example, in various cases the system uses a pre-treatment step to recover and utilize salt from the desalination brine water and also to produce usable (e.g., drinkable, industrial use) water in addition to the product water generated by the desalination process alone. In some cases, this pre-treatment step (which can reduce hardness and other fouling elements) can also or instead be incorporated into the desalination process. For example, the pre-treatment step may in some cases occur just prior to either the desalination primary or secondary reverse osmosis (RO) stages. The integration of the pre-treatment step can improve the recovery rate or efficiency of the desalination RO stage, thus allowing the extraction of a higher proportion of fresh water from the desalination feed water.

Other possible integrations include the desalination plant's use of certain value-added products (e.g., hydrochloric acid, sodium hydroxide, sodium carbonates, sodium bicarbonates, and/or gaseous CO₂) that are generated by the carbon capture process. As one possible example, in various implementations CO₂ gas produced from the liquid carbonate solution is used to remineralize the desalination plant's recovered freshwater stream.

In a further possible integration, in various cases, the carbon capture system absorbs CO₂ emissions generated as the desalination plant burns fossil fuel energy to power reverse osmosis and other desalination processes. For example, in various cases, the system captures and sequesters carbon dioxide from ambient air (e.g., in an air contactor) and also carbon dioxide flowing directly from industrial sources such as a desalination plant (e.g., in a bubble column or sparger reactor).

Accordingly, implementations of the disclosed technology incorporate various combinations of closely integrated processes, with several interdependencies and synergies, leading to an efficient system wherein one or more products are used interchangeably between the processes, resulting in advantages such as low carbon emissions and reduced waste stream. Additional features and benefits of the disclosed methods, systems, and devices will be further discussed and become apparent in light of the disclosed implementations.

Implementations of the disclosed systems and methods can be combined or otherwise utilized with other examples herein. In various cases the teachings of one or more implementations disclosed herein can apply and be used with other implementations disclosed herein, as well as with examples discussed in related U.S. application Ser. No. 18/082,903, filed Dec. 16, 2022, and entitled “SYSTEMS AND METHODS FOR DIRECT AIR CARBON DIOXIDE CAPTURE, which is hereby incorporated by reference in its entirety. Various implementations can make use of the technologies disclosed in the other examples and aspects, such that the teachings contained herein all relate to variations on the implementations disclosed elsewhere herein. One of skill in the art would readily appreciate that in certain implementations, features or other aspects disclosed in any specific example detailed herein can be combined with additional features outlined in alternate examples, such that the instant disclosure contemplates combining various features for individual applications of the disclosed technology.

As used herein and described with respect to the Figures, the disclosed technologies are often referred to broadly as a system 10, a capture system 10, a carbon capture system 10, a mineral recovery system 10, a recovery system 10, a carbon management and mineral recovery system 10, and variations thereof, though it is understood that this is for brevity and is in no way intended to be limiting to any specific modality.

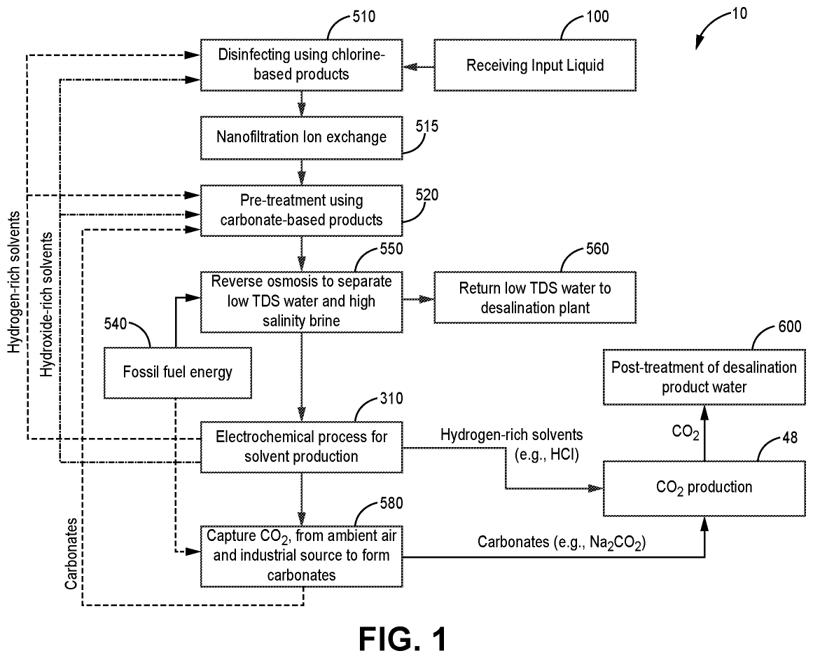

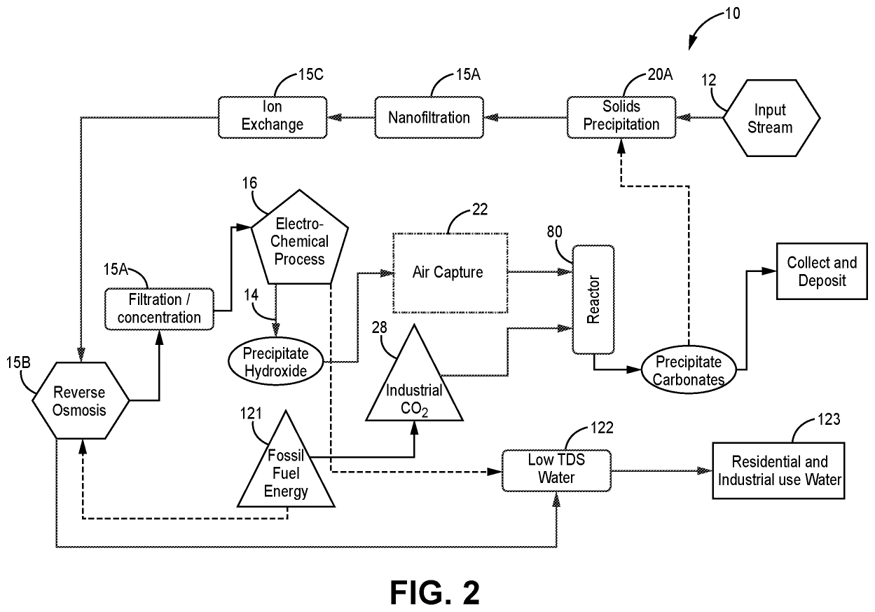

Turning to FIGS. 1-2, certain implementations of the capture system 10 relate to the sequestration of CO₂ and simultaneous recovery of low TDS water for residential and industrial purposes using only saline water (e.g., such as a brine reject, seawater and/or brackish groundwater) and electricity. In these implementations, electricity is applied to the input saline water via an electrochemical process including, for example, electrolysis or electrodialysis. In various implementations the electrochemical process creates hydroxide-rich solvents which can be used to directly capture CO₂ from the air. In various implementations the electrochemical process (e.g., electrodialysis or electrolysis) also creates a hydrogen-rich and chlorine-rich solvent stream that can be used for, e.g., disinfecting the low TDS water for its use.

FIGS. 1-2 depict various synergies and interdependencies among carbon capture and desalination processes according to various implementations of the capture system and process 10. In the depicted implementations, a variety of optional steps are performed. Turning to FIG. 1, for example, in various implementations the system 10 carries out a process having steps such as receiving input liquid (box 100) and disinfecting the input liquid with chlorine-based products (box 510) obtained from the electrochemical reaction (box 310) used to produce solvent for the carbon capture process (box 580). In various implementations, the input liquid is a brine output or reject from a desalination process. In such cases, the desalination process produces the brine reject (along with a low TDS or freshwater output) by desalinating saline feed water. In some cases the saline feed water is seawater. In some cases, the saline feed water is brackish groundwater. In some cases, the saline feed water may include another source or multiple sources of salt water.

The disinfected liquid product is then passed through additional pre-treatment stages that variously includes nanofiltration and ion exchange (box 515). The product is further pre-treated with carbonates such as sodium carbonate and sodium bicarbonate (box 520) which are obtained from the carbon capture process (box 580). The solution is then passed through reverse osmosis and other processes involved in the desalination of the water (box 550) to obtain a low TDS stream and a concentrated, high-salinity brine.

It should be appreciated that various process steps, system stages, equipment, and the like are described herein in the context of the carbon capture system and process 10 as “pre-treating” the input liquid. Unless specified otherwise or apparent from the context, this terminology is simply used at times to conveniently indicate that the described processing of the input liquid takes place upstream from and prior to an electrochemical process that produces a hydroxide-rich stream for capturing carbon dioxide.

In various implementations, the low TDS stream is returned to a desalination process or plant for residential and industrial use (box 560). The concentrated, high-salinity brine is then passed through an electrochemical process (box 310) such as electrolysis or electrodialysis for producing solvents including, for example, hydrogen-rich and/or hydroxide-rich solvents. A solvent, such as sodium hydroxide, is used to capture CO₂ (box 580) from ambient air as well as optionally from an industrial source, such as a fossil fuel energy generator (box 540) used to power the desalination process.

In various implementations the capture system 10 is configured to capture CO₂ in gas form. As shown in FIG. 1, the system 10 mixes 48 carbonates (e.g., sodium carbonate, Na₂CO₃) produced by the direct air CO₂ capture stage 580 with a hydrogen-rich stream (e.g., HCl) produced by the electrochemical process 310. This combination creates CO₂ in gas form and saltwater (not depicted). In some cases the salt water can be fed back to the liquid input stage 100 for reuse in the process. The gaseous CO₂ may be stored, sold, or otherwise used.

In various implementations, the gaseous CO₂ is used to remineralize the fresh water recovered by the desalination process in a post-treatment stage 600. Remineralization of the recovered product water can be important in order to reduce corrosion in water distribution systems and to add minerals for human health and other uses. The gaseous CO₂ can also be added to the pre-treatment stage, prior to primary or secondary reverse osmosis, to enable pH balancing as well as remineralization of water, thus increasing the efficiency of the process.

A number of methods can be used to remineralize the recovered product water. One example includes adding calcium hydroxide or hydrated lime to the product water and then adding carbon dioxide (in the form of carbonic acid) to the product water to form calcium bicarbonate. Another example includes using calcite contactors. In this process water flows through and dissolves limestone (calcite) media in reaction with carbon dioxide to form calcium bicarbonate. Typically, liquid CO₂ must be purchased and stored by desalination plants to facilitate these types of remineralization processes. The gaseous source of carbon dioxide produced by the capture system 10 can thus supplement and/or replace these traditional stores, leading to lower overall costs for desalination.

As shown in FIG. 2, in various implementations of the system 10, an input liquid 12 is fed into the capture system 10. In various implementations, the input liquid 12 is a brine reject liquid from a desalination plant. In some cases, the input liquid 12 may include a combination of two or more brine reject liquids, seawater, brackish groundwater, or another saline liquid 12. According to various implementations, the system 10 includes a precipitation stage 20A at which the input liquid 12 is pre-treated with carbonates produced by the carbon capture process.

The input liquid 12 is pre-treated and filtered to remove coarse particles in a filtration stage 15A and divalent ions such as calcium and magnesium in an ion exchange stage 15C. The input liquid 12 is then passed through a reverse osmosis unit 15B which uses energy from a fossil fuel generator 121 to recover sodium chloride from the input liquid. The reverse osmosis unit 15B separates the water into a low TDS water stream 122 that can be further disinfected with a hydrogen and chlorine-rich disinfectant before sending it back to the desalination process/plant for, e.g., residential and industrial use 123. In addition, the concentrate from the reverse osmosis stage 15B is filtered 15A, if needed, before being passed into an electrochemical processor 16 including a bipolar membrane electrodialysis stack to produce a hydroxide-rich stream 14 containing salts such as NaOH and/or other hydroxides and/or a hydrogen-rich stream containing acids such as HCl.

As described herein, it is understood that the capture system 10 shown in FIG. 2 comprises one or more fluidic and/or electrical connections (shown generally at the lines) between a variety of optional components that can be arranged in a wide variety of arrangements, such that the various fluids/gasses and electricity described herein are able to flow as described.

Some or all of the hydroxide solution 14 is then sent to a direct air CO₂ capture mechanism 22 for capturing carbon dioxide as carbonates and then sent to a capture mechanism or reactor 80 for capturing or absorbing an industrial source of carbon dioxide 28 as carbonates. This mechanism can be one of many existing approaches. In various cases the industrial source of carbon dioxide may be power generation emissions from a water treatment (e.g., desalination) plant. Once this stream 14 has progressed through the CO₂ capture systems and becomes saturated with carbon, it is again preferably sent to a precipitation system 20 to extract carbonates. In various implementations the precipitation system/tank 20 is connected upstream of the electrochemical processor 16. As shown in FIG. 2, the precipitation system 20 is coupled with the pre-treatment precipitation stage 20A so that the precipitated carbonates can be used for treating or conditioning the input liquid 12.

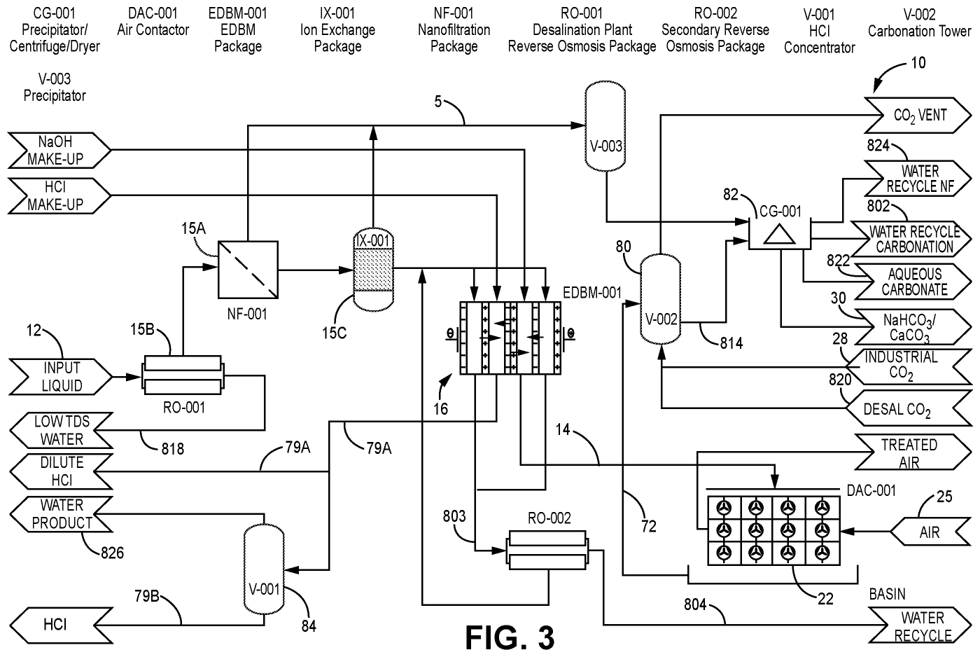

FIG. 3 is a flow chart providing a detailed depiction of a carbon capture and mineral recovery process, according to one possible implementation. The detailed diagram depicts a number of vessels and other components of the system, in addition to fluid connections between relevant components. It will be appreciated that the system may include fewer and/or additional components and aspects that are not shown in various cases.

Continuing with FIG. 3, in various implementations, a capture system and method 10 receives an input liquid 12. In various implementations, the input liquid 12 is a brine reject stream from a desalination plant or process. In some cases, the input liquid 12 is a brine reject stream in combination with, for example, seawater or brackish groundwater. The input liquid 12 is sent through a pre-treatment stage. In the illustrated example, the pre-treatment stage includes a reverse osmosis unit 15B in which the input liquid 12 is concentrated. Following the concentration, the resulting permeate 818 which contains a reduced level of dissolved salts (low TDS) is returned back to the desalination plant for residential and industrial use. The concentrated input liquid 12 from the reverse osmosis unit 15B is then fed to a nano-filtration unit 15A and an ion exchange unit 15C to remove divalent ions such as calcium and magnesium. The output of the pre-treatment stage (e.g., filtrate) is then sent to an electrochemical processor 16.

In various implementations, the electrochemical processor 16 includes an electrodialysis bipolar membrane. The EDBM unit is configured to split the input liquid salt stream into a hydroxide-rich stream 14 and a hydrogen-rich stream 79A. The hydroxide-rich stream is then passed through an air contactor 22 where it absorbs carbon dioxide from an air stream 25 to form a liquid carbonates solution. The carbonates solution 72 is then pumped to a reactor 80 (e.g., carbonation tower) which absorbs CO₂ from, e.g., industrial gases 28 and a desalination facility 820 to form a bicarbonates stream (e.g., slurry) 814. In various implementations, the bicarbonate stream 814 is separated using a solids separator 82 (e.g., a centrifuge dryer) into a solid carbonate/bicarbonate precipitant stream 30, an aqueous carbonate stream 822, and water, which in some cases is recycled back into the system 802, sent to a desalination facility 824, or both.

In various implementations, the process/system 10 uses one or more additional inputs and may generate one or more additional outputs. In some implementations, one or more ancillary inputs and/or outputs are largely recycled within the system. For example, in some cases, an output 803 from the electrochemical process 16 is processed (e.g., by reverse-osmosis) and provides low TDS water 804, which can be used as a makeup liquid for the EDBM unit. In some cases, an HCl makeup stream and/or NaOH makeup stream are also used to facilitate the EDBM unit.

As will be appreciated, additional inputs and/or outputs may be present in various implementations of the system 10, especially when the capture system 10 is integrated with another industrial process such as, for example, desalination. In various implementations the capture system/process 10 is configured to provide a number of outputs to a desalination facility. As shown in FIG. 3, in various implementations the outputs include one or more of
1) low TDS water 818 collected upstream from the electrochemical process as a RO permeate (e.g., up to 50%) and sent to the desalination facility;
2) dilute HCl 79A sent to the desalination facility for disinfectant and pH control;
3) water 826 recovered from concentrating HCl 79B; and
4) an aqueous carbonate solution 822 separated in the centrifuge dryer and sent to the desalination facility for removing hardness and for pH control.

In addition, in various implementations the system/process 10 is configured to receive and process CO₂ emissions 820 from the desalination facility, thus providing an efficient way of handling emissions generated by the desalination process.

Implementations of the direct air carbon capture process can further use a concentrated salt stream from reverse osmosis concentrate as an input liquid, thereby reducing the disposal needs of a desalination facility.

In various implementations, the dilute acid byproduct (e.g., HCl 79A) is sent to a concentrator 84 to produce a concentrated acid product 79B and also a pure water byproduct 826. In some cases, the concentrator 84 removes water by evaporation using e.g., heat and/or pressure. In various cases, the water byproduct 826 is clean with a low TDS similar to demineralized water and can be delivered to the desalination facility for use as a freshwater end product. In various implementations this step can produce 15% to 40% (e.g., 15% to 20%) of the total fresh water for the desalination facility.

As shown in FIG. 3, in various implementations the nanofiltration 15A and/or ion exchange step 15C optionally remove divalent ions (e.g., calcium and magnesium) from the input liquid 12 (e.g., brine, seawater, brackish water, etc.). The resulting high TDS stream 5, with divalent ions, can in some cases be mixed with carbonate products 814 to remove the hardness and lower the TDS of this water. In various implementations, the resulting water stream 824, after the precipitation step, can be recycled back to the desalination plant. In some cases, the recycled water stream 824 may be fed back to the beginning of the desalination process. In some cases the recycled water may be used (e.g., with or without optional additional chemical treatment) for industrial and/or agriculture purposes, or as drinking water or for another use. In various implementations, the amount of water recovered from this source could be between about 15% to 40% (e.g., 15% to 20%) of the total input liquid 12.

Accordingly, in some cases the desalination facility can reduce costs by operating reverse osmosis with lower recovery ratios and supplementing the recovered water with water produced by the carbon capture stage. For example, in some cases, the desalination facility can use the low TDS water 818 that is a byproduct of pre-treating the input liquid 12. In some cases the desalination product water may include the water 824 separated from the bicarbonate slurry 814. As another example, the desalination product water may also include the water 826 recovered from concentrating the hydrogen-rich stream 79A. In various implementations the water returned to the desalination facility from these various points in the carbon capture process is low TDS drinking water, thus allowing it to be mixed with the facility's freshwater output or otherwise used. In various implementations one or more recovered water streams may be introduced at other points in the water treatment facility's process.

As previously discussed, in various implementations one or more products generated by the direct air carbon capture process overlap with corresponding products used by the desalination facility for the pre-treatment of salty water and/or post-treatment of drinking water. Using these value-add products within the desalination process can advantageously reduce costs and recover additional water for reuse. In various implementations possible overlapping value-add products include, for example:
1. Carbonate products: In some cases, a final mineralized carbonate product is separated into both an aqueous form 822 and a slurry form 30. The slurry product 30 which in some cases may be sent for storage, can also be used like caustic in the precipitation softening of desalination feed water to help prevent scaling and membrane fouling. The captured CO₂ can be used for pH balance and remineralization either at the pre-treatment or post-treatment steps.
2. Dilute hydrochloric acid and sodium hydroxide: In various implementations, electrodialysis with bipolar membranes (EDBM) is used to produce an aqueous caustic sorbent 14 (e.g., sodium hydroxide) for the direct air capture process, and a dilute acid (e.g., hydrochloric acid) byproduct. In various implementations, these products can aid in the disinfection of the process water, in pH balancing, and in the removal of scaling buildup at desalination facilities. While in some cases the desalination facility's use of the dilute acid and base product may be small (e.g., <1% to up to 3% of the production), using the dilute acid and/or base products can optionally provide additional water to the desalination facility.
3. Additional water recovery after removing the mineral salts can be supplied back to the desalination facility, increasing its efficiency.

As discussed above, various implementations benefit from dual carbon capture technology. In such cases, the system 10 includes a direct air capture mechanism 22 alongside a secondary CO₂ capture unit 80 which reacts a high-purity gaseous CO₂ stream into a mineralized carbonate form. Any CO₂ emissions from energy production 28 or other means at the desalination facility 820 can be absorbed by this mechanism. This synergy can in some cases help prevent any decarbonization process for the desalination facility while also aiding to supplement the mineralized product of the system 10.

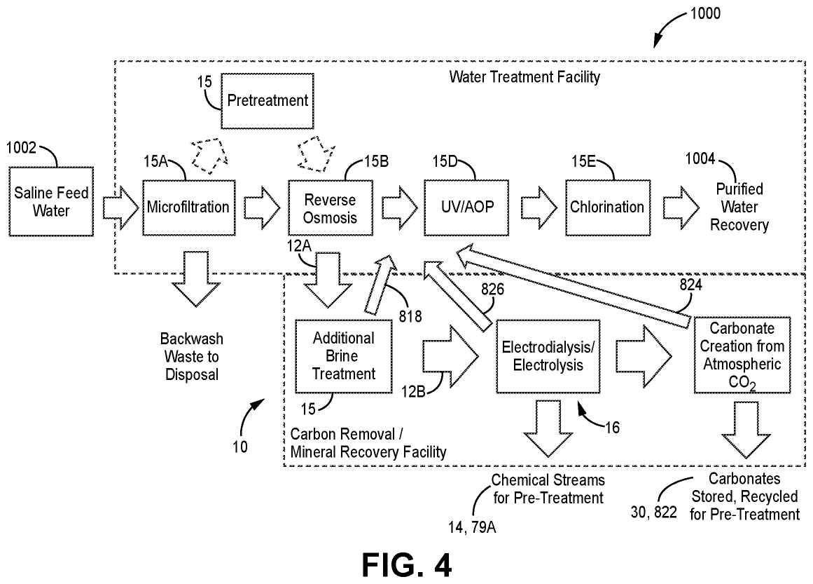

FIG. 4 is a schematic block diagram illustrating a system and method for treating water, mineral recovery, and removing carbon according to various implementations of the disclosed technology. According to this example, the operational flow of the carbon removal and mineral recovery system 10 is integrated with the operational flow of a water treatment facility 1000 configured to treat incoming saline feed water 1002. In various cases the incoming water 1002 is the effluent of a water reclamation plant. In particular, the treatment facility produces a brine reject stream that is used for the saline input liquid 12A for the system 10. In various implementations, as discussed elsewhere herein, the system 10 operates to recover salt from the input liquid and thus provide additional water 818 to the water treatment facility 1000 (e.g., for use in industrial and residential purposes). In various implementations, the system 10 pre-treats 15 the brine liquid input 12A, which is then used in an electrochemical process 16 to produce a solvent (e.g., sodium hydroxide). The solvent reacts with carbon dioxide in ambient air to form carbonate (sodium carbonate), which can then be precipitated and stored for permanent removal 30. The carbonates can also or instead be used within the mineral recovery/water treatment systems to, for example, pre-treat the saline feed water 1002 and/or the brine reject liquid 12A.

According to various implementations, the water treatment facility 1000 may purify, desalinate, or otherwise treat incoming water to recover a low TDS water output 1004. The incoming water 1002 may typically be a high salinity water with higher than desired TDS. In various implementations the incoming water 1002 is brackish ground water collected by a water reclamation plant. Other examples of saline water, including seawater and combinations of various saline sources are also possible.

In some cases the treatment process 1000 involves one or more of a variety of known stages, including, for example, microfiltration 15A, reverse osmosis 15B, ultraviolet advanced oxidation treatment 15D, and/or chlorination 15E. In various implementations, the reverse osmosis stage produces a high salinity brine reject stream 12A which is used as the input liquid 12A for the mineral recovery system 10.

According to various implementations, the system 10 includes additional brine treatment 15 prior to the electrochemical process 16, which may include electrodialysis or electrolysis. In some cases the additional brine treatment 15 is simply referred to as brine treatment or brine pre-treatment.

The brine treatment 15 is helpful, and in some cases necessary, for removing hardness and/or controlling the pH of the brine reject liquid 12A in order to reduce or prevent scaling of the electrochemical mechanism 16 (e.g., electrodialysis membranes). In various cases, the pre-treatment reduces the divalent cation content in the brine by precipitating minerals from the liquid (e.g., Ca++ and Mg++ as calcium carbonate and magnesium hydroxide). In various implementations, a hydroxide and a carbonate are used to lower the hardness of the brackish water RO brine 12A according to the following relationships:

X(HCO₃)₂+2 NaOH [symbol] XCO₃+Na₂CO₃+H₂O (1)

YSO₄+Na₂CO₃ [symbol] YCO₃+Na₂SO₄ (2)

ZCl₂+NaOH [symbol] Z(OH)₂+2NaCl (3)
in which X and Y may be, for example, Ca, and Z may be, for example, Mg.

Additional pre-treatment steps can include nanofiltration or ion exchange to reduce the divalent ions in the pre-treated product. Since the pH of the solution decreases with the addition of the alkaline solutions of sodium hydroxide and sodium carbonate, hydrochloric acid can be added to restore the pH back to neutral levels. As discussed with respect to FIGS. 1-3, in various implementations one or more of these chemicals (e.g., sodium hydroxide 14, sodium carbonate 30/822, and hydrochloric acid 79A) or other chemicals are produced by the carbon capture/mineral recovery system 10, and can thus be used for pre-treatment purposes. In various implementations one or more of these chemicals can also be sent to the water treatment facility for treating or pre-treating water. The overlap in products and treatment needs provides additional potential synergies between the water treatment system 1000 and the mineral recovery system 10.

In various implementations, the amount and type of brine pre-treatment steps depends upon the particular composition of the water treatment brine 12A and the input brine requirement for the carbon capture/mineral recovery system 10. In various implementations the pre-treatment includes one or more of the following steps:
1. Addition of sodium hydroxide 14 and sodium carbonate 30/822
2. Filtration to remove the precipitate
3. Adjust pH to neutral using hydrochloric acid 79A
4. Optional nanofiltration and ion exchange to further reduce the divalent ions
5. Optional RO step if needed to concentrate the brine further

According to various implementations, the desalination process 1000 includes an optional feed water pre-treatment stage 15 just prior to the primary and/or secondary RO stages. The optional pre-treatment stage 15 can include similar and/or the same filtering and water treatment processes as discussed with respect to the additional brine treatment stage 15 prior to electrodialysis/electrolysis 16. This optional pre-treatment stage 15 can reduce hardness and other fouling elements in the desalination feed water and improve the efficiency and total water extraction by the primary/secondary RO stage(s).

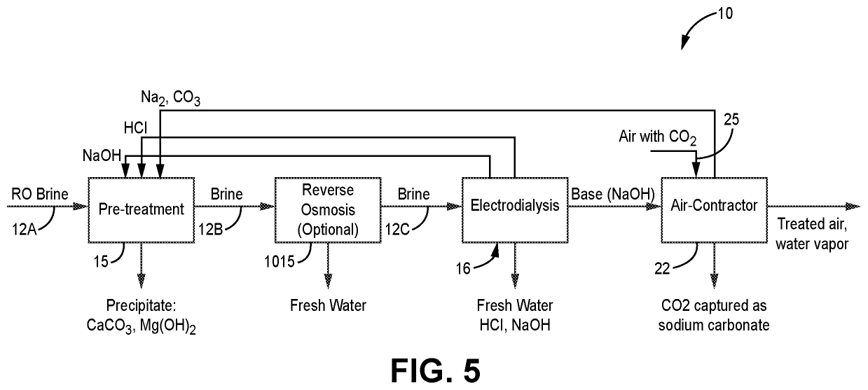

FIG. 5 is a flow diagram illustrating an example of the carbon capture and mineral recovery system 10 according to various implementations. In the illustrated example, the system 10 includes an additional, optional reverse osmosis stage 1015 following the pre-treatment stage 15. This can be helpful in various implementations in which the input liquid 12 (e.g., RO brine) has a lower TDS, since the additional RO stage 1015 can recover additional fresh water by producing an even more concentrated brine 12C for the electrochemical process 16. Such an arrangement may be useful, for example, when the input liquid 12A results from brackish water or another relatively low TDS source, especially when compared with the higher TDS of seawater.

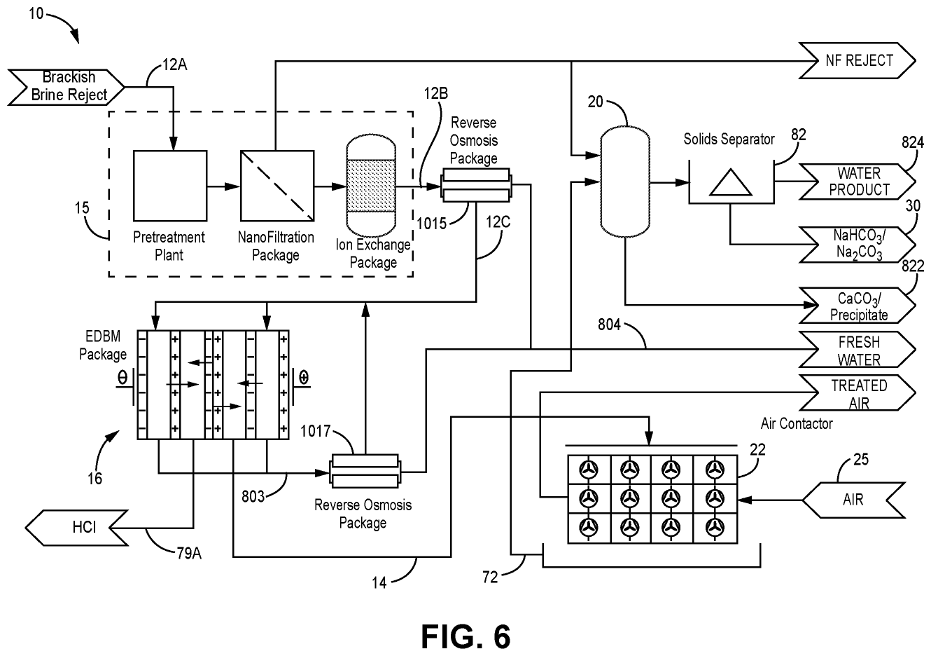

FIG. 6 is a flow chart providing a schematic depiction of the carbon capture and mineral recovery process 10 according to various implementations. The detailed diagram depicts a number of vessels and other components of the system, in addition to fluid connections between relevant components. It will be appreciated that the system may include fewer and/or additional components and aspects that are not shown in various cases.

As discussed elsewhere herein, the system 10 is designed for carbon-dioxide capture from ambient air and in some cases from industrial sources (e.g., power generation emissions). A first step in the process technology is to use the input liquid 12A to create a sorbent for CO₂ capture. As discussed elsewhere herein, in various implementations the input liquid 12A is a brine reject stream produced by a desalination or other water purification or treatment system. In some cases the brine reject stream 12A is produced by a water treatment facility that treats brackish ground water or other brackish water. For example, the system 10 in FIG. 6 can in various cases be an example of the mineral recovery system 10 shown in FIG. 4 integrated with the water treatment facility 1000.

According to various implementations, the system and method 10 splits the brackish brine reject liquid 12A into a dilute base (e.g., sodium hydroxide) and a dilute acid (e.g., hydrochloric acid). The base (e.g., a hydroxide-rich stream) is then used to capture carbon dioxide into a liquid carbonate solution. The carbonates can then be precipitated in various cases as sodium carbonate and/or sodium bicarbonate. In some cases where calcium and magnesium are available, some or all of the sodium carbonate/bicarbonate can be further converted into other carbonates. In various cases the stream of carbonates is transferred to a storage location for long-term sequestration. In various implementations the carbonates are also or instead used to treat the input liquid 12A and/or sent to a water treatment facility for pre-treating or post-treating water.

Returning to FIG. 6, in some cases, the input liquid 12A is first passed through one or more pre-treatment stages 15 that may include micro-filtration, nano-filtration, and ion-exchange units to remove divalent ions such as calcium and magnesium from the saltwater input. This saltwater 12B, free of divalent ions and other hardness/impurities, typically 10,000-100,000 TDS, is then passed to an electrochemical processor 16, which in various cases is an electrodialysis unit.

In various implementations, the system 10 includes an additional, optional reverse osmosis stage 1015 following the pre-treatment stage 15. In some cases the reverse osmosis stage 1015 may be considered to be part of the pre-treatment stage 15. The reverse osmosis stage 1015 can be helpful in various implementations in which the input liquid 12A (e.g., RO brine) has a lower TDS, since the additional RO stage 1015 can recover additional fresh water 804 by producing an even more concentrated brine 12C for the electrochemical process 16. Such an arrangement may be useful, for example, when the input liquid 12A results from brackish water or another relatively lower TDS source, especially when compared with the higher TDS of seawater.

In various implementations, the primary application for electrodialysis is seawater and brackish water desalination for freshwater production and brine water concentration for salt production. As will be appreciated, electrodialysis processes differ from other separation processes, such as distillation and reverse osmosis, in that dissolved solids are moved away from the feed stream rather than the feed stream being moved away from the dissolved solids. Since the concentration of dissolved solids in the feed stream is relatively low, electrodialysis offers a much higher feed stream recovery in many applications.

In various implementations, the electrodialysis unit 16 includes a plate-and-frame ion exchanger and a water-splitting device. The unit 16 moves ions through selective ion exchange membranes while the bipolar membranes are catalyzed to split water into H+ and OH− ions. The cations and anions that are separated by the ion exchange membranes are selectively combined with OH− and H+ ions to form caustic (e.g., sodium hydroxide) and acid (e.g., hydrochloric acid). In various cases the reaction is as follows:

NaCl+H₂O [symbol] NaOH+HCl (4)

In various cases, the caustic and acid are diluted (e.g., about 1 N) as they outflow from the electrodialysis unit 16.

In various implementations the electrodialysis unit 16 converts the input brine 12C into three products: sodium hydroxide (NaOH) 14, hydrochloric acid (HCl) 79A, and lean salt brine 803. In various cases, the lean salt brine product 803 can be further concentrated and recycled back to the inlet of the electrodialysis unit 16 to improve salt recovery (up to 100%). As an example, FIG. 6 illustrates how the system 10 includes an additional reverse osmosis package 1017 connected between the output of the electrodialysis unit 16 and the input of the unit 16.

Returning to FIG. 6, a second step in the process technology is to use the liquid sorbent (e.g., sodium hydroxide) 14 for capturing CO₂ from ambient air 25. In various cases a crossflow cooling tower 22 is used wherein the liquid solvent 14 flows vertically from the top to the bottom over packing materials and the air 25 moves horizontally, entering from sides and exiting in the middle, at the top. In various implementations, the CO₂ from ambient air 25 (e.g., typically at 300-400 ppm level) is absorbed in the liquid sodium hydroxide solution to form sodium carbonate. In some cases, about 70% of the CO₂ from the ambient air is absorbed as the air moves through the cooling tower and air with lean CO₂ (e.g., typically 100-200 ppm) will leave the cooling tower.

In some cases, the chemical reaction occurring in the capture mechanism/air contactor 22 is given by equation (5) below:

NaOH+CO₂ [symbol] Na₂CO₃+H₂O (5)

The reaction is mildly exothermic with a Gibbs free energy (AG) of 128.97 kJ/mol. The increase in temperature is very small as the cooling tower 22 affects the temperature in the opposite direction.

In various cases, depending on the relative humidity of the air coming in, some of the water from the liquid sodium hydroxide solution is evaporated as well, thus increasing the relative humidity of the outflow air stream to close to 100%.

Continuing with FIG. 6, in various implementations, the 1 N NaOH product 14 is used in the air contactor 22 unit to perform direct air capture (DAC) of carbon. According to various examples, the NaOH 14 is pumped up to the top of the air contactor 22 and evenly distributed across the area of the contactor fill. In some cases, the contactor fill is made of PVC material to prevent corrosion. Ambient air 25 is pulled into the contactor perpendicular to the NaOH sorbent flow from a large axial fan that sits on top of the contactor structure. In some cases, the velocity of the inlet air 25 is about 1-2 m/s with a CO₂ fraction of about 0.06% by mass.

The absorption of CO₂ into NaOH produces sodium carbonate (Na₂CO₃) 72. In various implementations, the carbonate product 72 is in an aqueous solution which can be used to reduce and/or prevent fouling and sedimentation, such as inside the equipment and piping.

According to various implementations, the dilute sodium carbonate stream 72 can be used to precipitate calcium and magnesium in water as carbonates 822 or separated out as sodium carbonate solids 30 using a solid separator 82 such as a dryer or evaporator. In various implementations the water 824 separated from the solids can then be recycled back into the system 10 and/or output for use, e.g., by sending it to a water treatment facility. The carbonates can be utilized or transferred for storage on land or in water. The mineralized carbonates that are stored mirror rocks such as, for example, trona (sodium carbonate-bicarbonate), limestone (calcium carbonate), and magnesite (magnesium carbonate) that have been naturally preserved for thousands of years.

According to various implementations, the some parts of the process 10 or the entire process flow 10 can be achieved at ambient temperature without any need for thermal energy. Various implementations of the process 10 can thus operate with lower levels of input power that can in some cases be provided by renewable energy sources. In some cases some or all parts of the process 10 are entirely powered by renewable energy sources. Furthermore, in some cases, the unit processes and their energy consumption allow for electrical and load flexibility necessary for demand-side management. Furthermore, the complete reliance on renewable energy sources in some cases enables the technology to yield a high net negativity for carbon capture even after a thorough life cycle analysis.

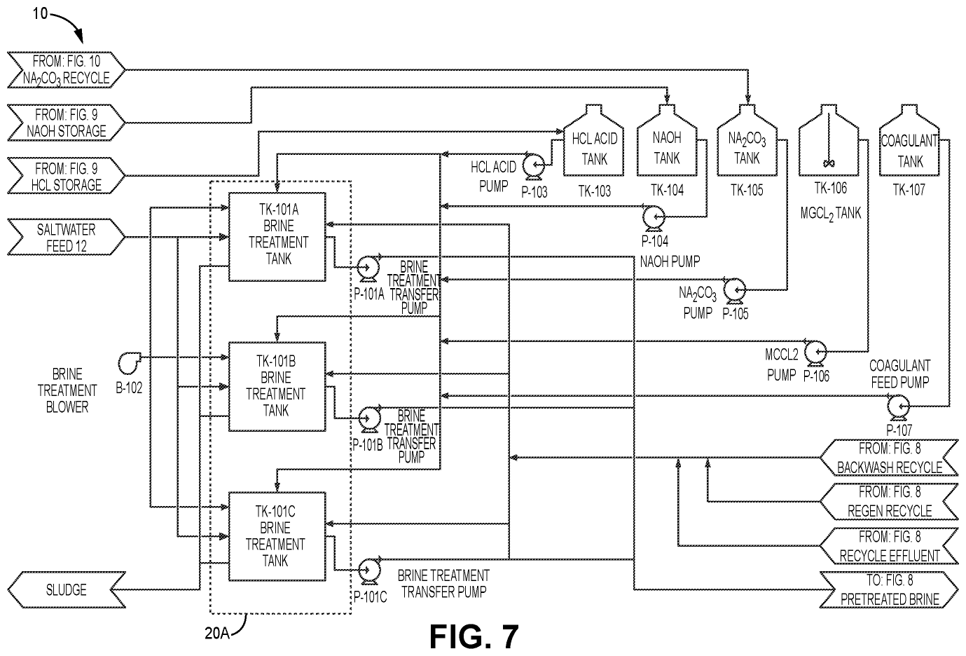

FIGS. 7-10 are a flow chart providing a detailed depiction of the carbon capture system and process 10 according to various possible implementations. The detailed diagram depicts a number of tanks, pumps, and other components of the system 10, in addition to fluid connections between relevant components. It will be appreciated that the system may include fewer and/or additional components and aspects that are not shown in various cases.

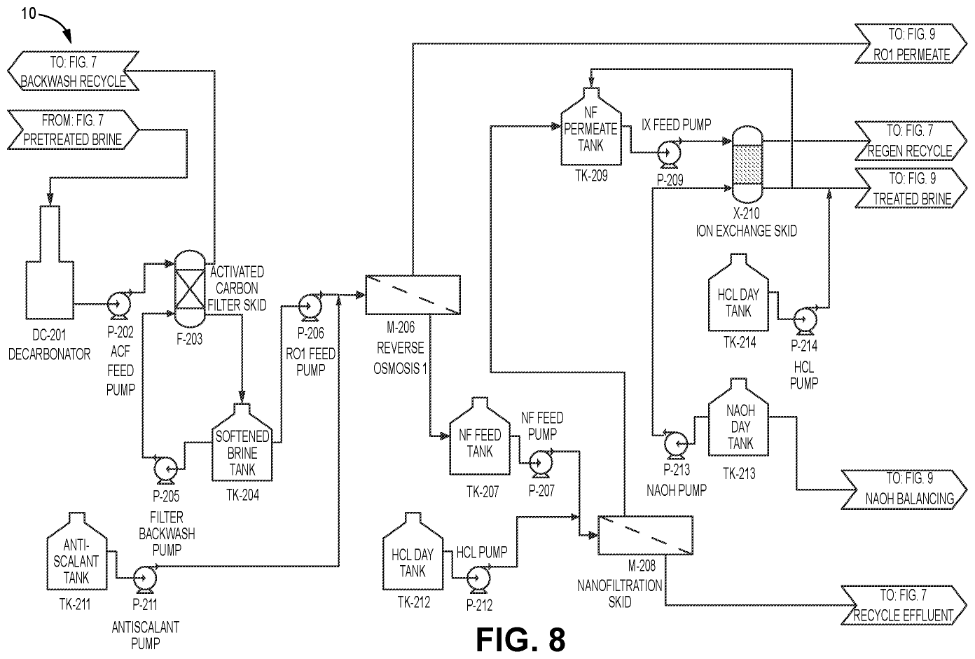

Turning to FIG. 7, in various implementations the capture system 10 receives an input liquid, such as, for example, an input liquid 12 including a saltwater feed. In various cases the system 10 may receive the input liquid from a RO brine stream, such as a brine reject stream from a desalination plant. In the illustrated example, the input liquid 12 is then sent through a pre-treatment stage. In various cases the pre-treatment stage includes a chemical precipitation 20A (shown in FIG. 7) followed by nano-filtration [M-208] and ion exchange unit [IX-210] (shown in FIG. 8) to remove divalent ions such as calcium and magnesium.

As shown in FIG. 7, in various implementations the chemical precipitation step 20A takes place in one or more precipitation tanks [TK-101A, B, C] where the saltwater feed 12 is mixed with precipitation chemicals such as sodium carbonate, sodium hydroxide, and hydrochloric acid, and others as needed that are stored in tanks [TK-103-107]. Corresponding pumps [P103-107] send the pre-treatment chemicals from the storage tanks to the precipitation tanks. In various implementations one or more of the chemicals are generated downstream in the capture process 10 as shown by the flow diagram in FIGS. 7-10 and discussed elsewhere herein. The sludge that results from the precipitation step 20A is removed and the pre-treated brine is passed downstream for further treatment.

In various cases additional recycling and cleaning streams are included to optimize the process and reduce the waste streams. For example, FIG. 8 illustrates that in some cases a Backwash Recycle stream, a Regen Recycle stream, and/or a Recycle Effluent stream are produced in later stages of the system and process 10 and pumped back into the precipitation tanks for further treatment and precipitation as shown in FIG. 7.

Continuing with FIG. 8, the pre-treated brine is passed through the nanofiltration unit [M-208] and the ion exchange unit [IX-210]. In various implementations the brine is passed through one or more intermediate process units to prepare the brine for the nanofiltration unit [M-208]. In some cases the intermediate units includes a decarbonator [DC-201] to remove dissolved CO₂, activated carbon filters [F-203] to remove dissolved organic compounds, and/or a reverse osmosis unit [M-206] to further concentrate the brine.

The system 10 can include various pumps and tanks to provide operation flexibility. For example, in various cases the nanofiltration product is stored in a nanofiltration permeate tank [TX-209] before being pumped [P-209] into the ion exchange unit [IX-210]. As shown in FIGS. 7-8, in this example the nanofiltration effluent is recycled back to the chemical precipitation tanks to reduce the waste liquid discharge. In addition, in various cases the ion exchange resin is regenerated from time to time using NaOH from an NaOH day tank [TK-213] and pump [P-213]. Further, in various cases the treated brine that is the product of the ion exchange unit [IX-210] is pH balanced using hydrochloric acid from an HCl day tank [TK-214] and pump [P-214].

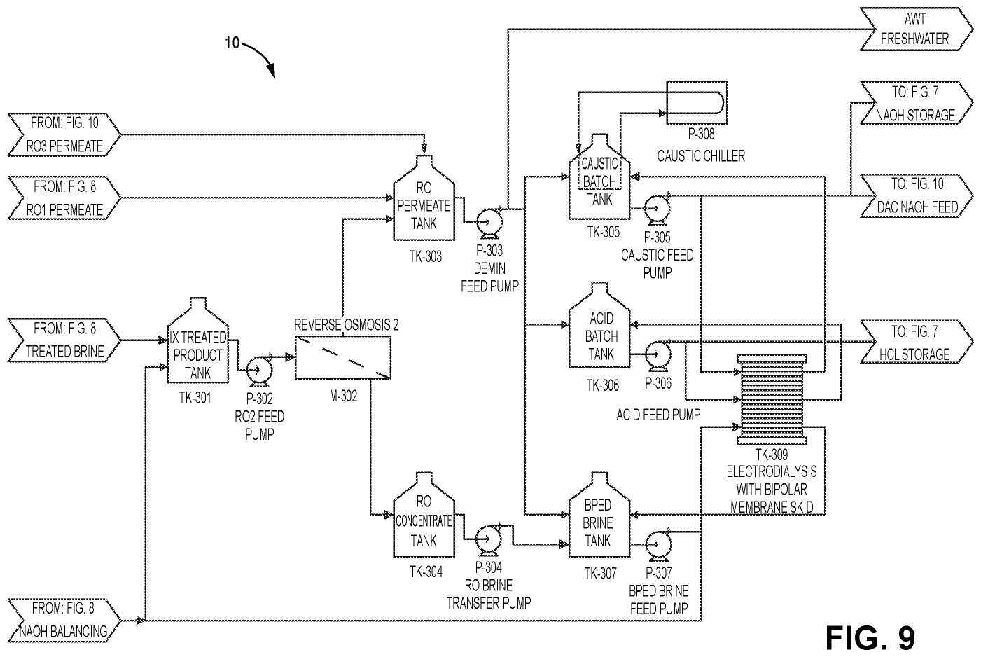

Turning to FIG. 9, in various cases the treated brine is passed through a reverse osmosis unit [M-302] for additional concentration of the salt before the salt brine is transferred to an electrochemical processor, which in various examples is an electrodialysis unit [ED-309]. The system 10 includes additional tanks and pumps as shown in FIG. 9 to store and move various streams through the depicted process steps. In the illustrated implementation, the electrodialysis unit [ED-309] produces a hydroxide-rich stream of NaOH that is stored in a caustic batch tank [TK-305] for further processing and reuse. The electrodialysis unit also produces an HCl stream that is sent to an acid batch tank [TK-306] for further processing and reuse. In some cases a chiller [E-308] may be employed to dampen temperature variations within the caustic batch tank [TK-305].

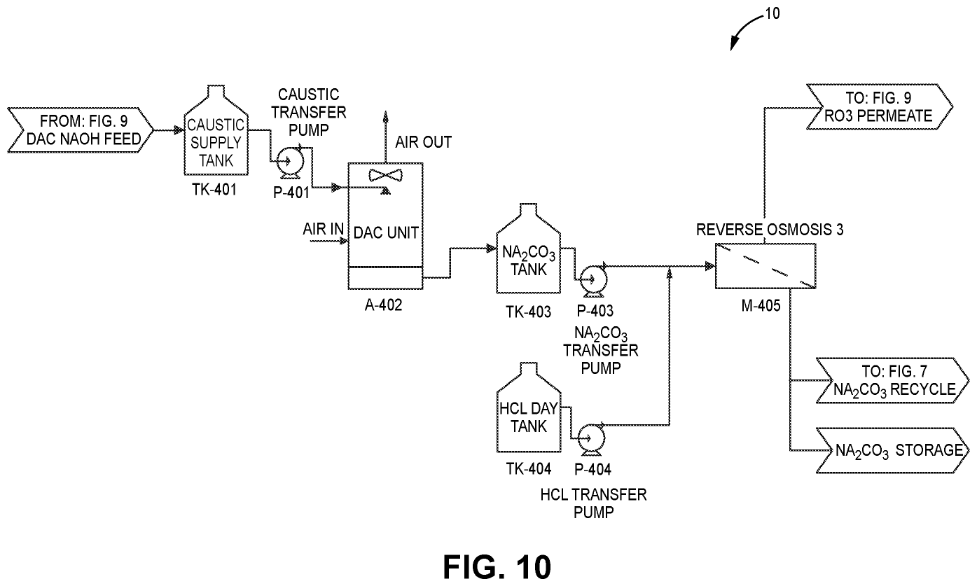

FIG. 10 depicts another portion of the carbon capture system and process 10 that includes using the hydroxide-rich feed from the electrodialysis unit [ED-309] for direct air capture (DAC) of carbon dioxide. The hydroxide-rich stream (e.g., including NaOH) is sent from the electrodialysis unit [ED-309] to a caustic supply tank [TK-401]. From there, a transfer pump [P-401] sends the hydroxide-rich stream through the direct air capture unit [A-402]. The resulting product, e.g., a sodium carbonate solution, is stored in a tank [TK-403] and can be further concentrated in another reverse osmosis unit [M-405] before being sent to the chemical precipitation step or disposed of for storage.

Although the disclosure has been described with reference to preferred embodiments, persons skilled in the art will recognize that changes may be made in form and detail without departing from the spirit and scope of the disclosed apparatus, systems, and methods.

What is claimed is:

1. A method for capturing and sequestering carbon dioxide (CO₂), comprising:
receiving an input liquid comprising a brine reject stream from a water treatment facility;
processing the input liquid with one or more of a filtration system, a reverse osmosis system, and an ion exchange system;
performing an electrochemical process on the input liquid to produce at least one hydroxide-rich stream; and
capturing CO₂ from air using the hydroxide-rich stream and a passive air capture system, thereby producing a liquid carbonate solution containing air-captured CO₂.

2. The method of claim 1, further comprising precipitating air-captured CO₂ from the liquid carbonate solution.

3. The method of claim 1, further producing a hydrogen-rich stream with the electrochemical process and mixing the hydrogen-rich stream with the liquid carbonate solution to generate gaseous CO₂.

4. The method of claim 3, further comprising sending the gaseous CO₂ to the water treatment facility for remineralizing product water.

5. The method of claim 1, further comprising:
precipitating carbonates from the liquid carbonate solution;
pre-treating the input liquid with the precipitated carbonates upstream from the electrochemical process; and
processing the input liquid with a reverse osmosis system to recover water from the input liquid prior to the electrochemical process.

6. The method of claim 5, further comprising treating the input liquid and/or the recovered water with a hydrogen-rich stream produced at least in part by the electrochemical process.

7. The method of claim 1, further comprising mixing CO₂ from an industrial CO₂ source with the liquid carbonate solution to produce a bicarbonate stream.

8. A method for capturing and sequestering carbon dioxide (CO₂), comprising:
receiving an input liquid comprising a brine reject stream from a water treatment facility;
performing an electrochemical process on the input liquid to produce at least one hydroxide-rich stream;
producing a chemical stream with the electrochemical process or downstream from the electrochemical process;
using the chemical stream to pre-treat the input liquid upstream from the electrochemical process; and
capturing CO₂ from air using the hydroxide-rich stream and a passive air capture system, thereby producing a liquid carbonate solution containing air-captured CO₂.

9. The method of claim 8, wherein producing the chemical stream comprises precipitating carbonates from the liquid carbonate solution.

10. The method of claim 8, wherein producing the chemical stream comprises producing a hydrogen-rich stream at least in part with the electrochemical process.

11. The method of claim 8, wherein the chemical stream comprises the hydroxide-rich stream.

12. The method of claim 8, wherein producing the chemical stream comprises mixing CO₂ from an industrial CO₂ source with the liquid carbonate solution to produce a bicarbonate stream.

13. A method for capturing and sequestering carbon dioxide (CO₂), comprising:
receiving an input liquid comprising a brine reject stream from a water treatment facility;
performing an electrochemical process on the input liquid to produce at least one hydroxide-rich stream;
capturing CO₂ from air using the hydroxide-rich stream and a passive air capture system, thereby producing a liquid carbonate solution containing air-captured CO₂; and
producing a water stream comprising recovered water for use by the water treatment facility.

14. The method of claim 13, further comprising processing the input liquid with reverse osmosis to produce at least part of the recovered water.

15. The method of claim 13, further comprising processing the liquid carbonate solution to produce at least part of the recovered water.

16. The method of claim 13, further comprising mixing CO₂ from an industrial CO₂source with the liquid carbonate solution to produce a bicarbonate stream and processing the bicarbonate stream to produce at least part of the recovered water.

17. The method of claim 13, further comprising producing a hydrogen-rich stream at least in part with the electrochemical process.

18. The method of claim 17, further comprising concentrating the hydrogen-rich stream to produce at least part of the recovered water.

19. The method of claim 17, wherein the hydrogen-rich stream comprises hydrochloric acid.

20. The method of claim 17, further comprising generating gaseous CO₂ for use by the water treatment facility by mixing the hydrogen-rich stream with the liquid carbonate solution.
